(19) United States
(12) Patent Application Publication
(10) Pub. No.: US 2008/0203367 A1
(43) Pub. Date: Aug. 28, 2008

(54) ELEVATING DEVICE

(75) Inventor: Kengo Ashizawa, Nirasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 12/041,979

(22) Filed: Mar. 4, 2008

(30) Foreign Application Priority Data
Jan. 16, 2007 (JP) 2007-006594

(51) Int. Cl. B66F 3/08

(52) U.S. Cl. 254/98

(57) ABSTRACT

In an elevating device for raising and lowering a heavy member by rotating a rotation axis extending in a direction crossing a vertical direction, the rotation axis has one end portion to which the heavy member is connected. The rotation axis includes a bendable portion adapted to transmit a rotational force. A leading end portion of the free end portion is vertically suspended from the bendable portion of the rotation axis regardless of a stop position of the rotation axis. A rotation applied by the heavy member to the rotation axis is suppressed by the suspended leading end portion. With such an elevating device, unexpected rotation of the rotation axis is positively suppressed in a cost-effective manner.

### FIELD OF THE INVENTION

The present invention relates to an elevating device for raising and lowering a heavy member by rotating a rotation axis; and, more particularly, to an elevating device having a mechanism for preventing unexpected rotation due to gravity of the heavy member while the rotation axis stops.

### BACKGROUND OF THE INVENTION

Conventionally, a ball screw mechanism has been widely used for raising and lowering a heavy member. For example, a plasma etching apparatus has a radio frequency power supply unit for plasma generation as a heavy equipment weighing about 70 kg to about 80 kg, and the ball screw mechanism is used for raising and lowering the radio frequency power supply unit which needs to be raised and lowered for maintenance. Specifically, when a rotation axis is rotated by using a handle, the rotation of the rotation axis is transferred to a shaft of a ball screw through a gear train, thus raising and lowering the radio frequency power supply unit.

In that case, however, while the rotation of the rotation axis stops, the raised heavy equipment may move down by reversely rotating the rotation axis by its gravity.

This may theoretically be prevented by making a lead angle of the ball screw smaller than a static friction angle so that a self-locking action is obtained. In this case, however, since the static friction angle of the ball screw is small, the lead angle of the ball screw becomes extremely reduced. As a result, a pitch of the screw is reduced, which is not practical.

In order to prevent the aforementioned problem, there have been proposed a ratchet mechanism disclosed in Japanese Patent Laid-open Publication No. H11-125318 and a friction break.

However, the ratchet mechanism acts in only one direction, and may be released. If it is released, it cannot function to prevent a reverse rotation. Further, a ratchet claw or the like may be broken, so that the ratchet mechanism has a poor reliability in general. Meanwhile, when the friction brake is used, a brake pad needs to be replaced when it is worn out, increasing the cost of consumables. Besides, the brake needs to be adjusted regularly, so that the maintenance cost increases.

In a case where a worm wheel and a worm gear are provided in the gear train between the rotation axis and the ball screw shaft, a reverse rotation can be prevented by making a lead angle of the worm gear smaller than a static friction angle so that a self-locking mechanism is obtained. However, if an initial speed is applied thereto, no brake does work other than the friction between the gears. As a result, the heavy equipment may move down due to the rotation of the gears.

### SUMMARY OF THE INVENTION

It is, therefore, an object of the present invention to provide an elevating device capable of positively preventing unexpected rotation of a rotation axis due to gravity of a heavy member in a cost-effective manner.

The present inventors have noticed that an initial speed of a rotation axis is slow at first but gradually accelerates, like a speed increase on a slope. That is, the present inventors have found that a reverse rotation of the rotation axis can be easily prevented by suppressing the rotation of the rotation axis while no initial speed is applied thereto.

In accordance with the present invention, there is provided an elevating device for raising and lowering a heavy member by rotating a rotation axis extending in a direction crossing a vertical direction, the rotation axis having one end portion to which the heavy member is connected and the other free end portion, wherein the rotation axis comprises a bendable portion adapted to transmit a rotational force and to be bent regardless of a rotation stop position of the rotation axis; and a leading end portion of the free end portion adapted to be vertically suspended from the bendable portion of the rotation axis, a rotation applied by the heavy member to the rotation axis being suppressed by the suspended leading end portion.

For example, the rotation applied by the heavy member to the rotation axis can be suppressed by making a braking torque applied to the rotation axis due to a weight of the suspended leading end portion greater than a rotational torque applied by the heavy member to the rotation axis.

Furthermore, when the suspended free end portion is rotated by the rotational force applied by the heavy member to the rotation axis, the rotation of the rotation axis is suppressed by the contact between the leading end portion and a wall surface or the like adjacent thereto. In this case, the weight of the leading end portion becomes no problem. Even when an initial speed is applied to the rotation axis, the rotation of the rotation axis can be prevented after the leading end portion contacts with the wall surface or the like.

The bendable portion has one or more links as a part of the rotation axis, and each of the links has both end portions rotatably coupled to another link or the rotation axis wherein respective coupling shafts provided at both ends of the link are extended in different directions. Accordingly, even when the rotation axis stops at any rotation angle, the leading end portion can be vertically suspended. In case the number of the links is one and the coupling shafts provided at both sides of the link are extended perpendicular to each other, the leading end portion can be vertically suspended more readily.

The rotation axis and the heavy member may be connected to each other through a ball screw for raising and lowering the heavy member and a gear train for connecting the ball screw and the rotation axis.

### BRIEF DESCRIPTION OF DRAWINGS

The above and other objects and features of the present invention will become apparent from the following description of preferred embodiments given in conjunction with the accompanying drawings, in which:

FIG. 1 is a perspective view of an etching apparatus using an elevating device in accordance with an embodiment of the present invention;

FIGS. 2A and 2B show a schematic cross sectional view of principal parts taken along line A-A of FIG. 1 and a view thereof seen in the direction of arrow B of FIG. 1, respectively;

FIGS. 3A and 3B illustrate a configuration of the elevating device, wherein FIG. 3A is a front view thereof seen in the direction of arrow B of FIG. 1, and FIG. 3B provides a bottom view thereof;

FIG. 4 offers a perspective view depicting a state where a handle 40 is attached to a rotation axis 30;

FIG. 5 presents a perspective view showing a state where the handle 40 is separated from the rotation axis 30;

FIGS. 6A and 6B represent a state where a leading end portion is suspended regardless of a rotation angle of the rotation axis; and

FIG. 7 describes another embodiment of the present invention.

### DETAILED DESCRIPTION OF THE PREFERRED EMBODIMENTS

Hereinafter, embodiments of the present invention will be described with reference to the accompanying drawings.

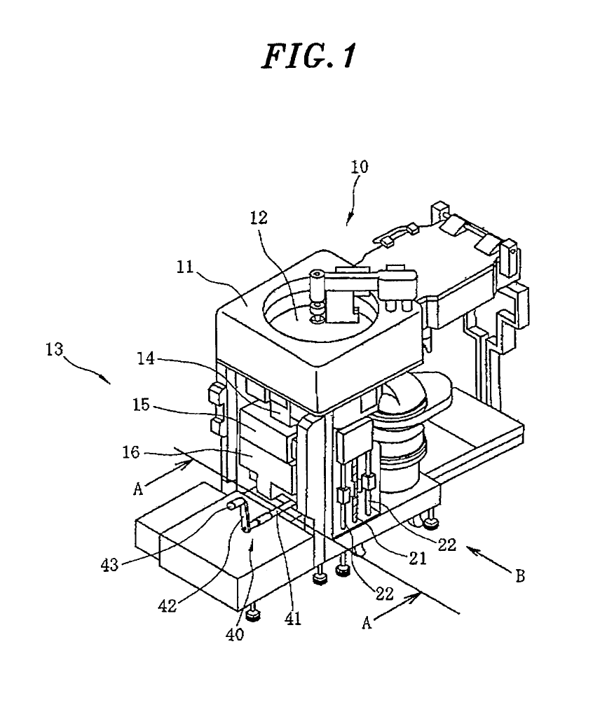

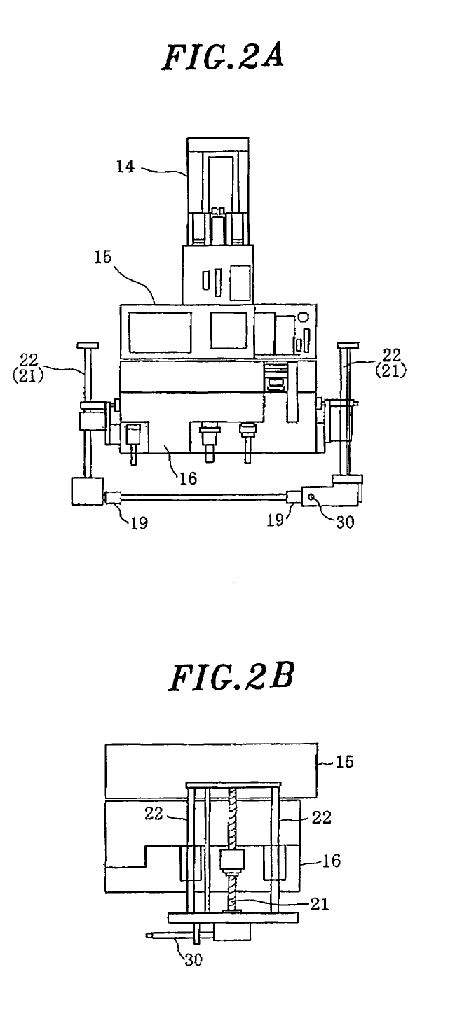

Here, there will be described a case where the present invention is applied to a plasma etching apparatus as an example. FIG. 1 is a perspective view of an etching apparatus using an elevating device in accordance with an embodiment of the present invention; and FIGS. 2A and 2B show a schematic cross sectional view of principal parts taken along line A-A of FIG. 1 and a view thereof seen in the direction of arrow B of FIG. 1, respectively.

A plasma etching apparatus 10 includes an airtight chamber (processing chamber) 11 having a wall made of, e.g., aluminum. In the chamber 11, there are provided a susceptor (not shown) for horizontally supporting a semiconductor wafer (hereinafter, simply referred to as “wafer”) as a target substrate, the susceptor serving as a lower electrode, and an upper electrode 12 disposed above the susceptor to face it. The plasma etching apparatus 10 is constructed as a lower side dual frequency application type in which a first radio frequency power of a higher radio frequency (e.g., 100 MHz) for plasma generation and a second radio frequency power of a lower radio frequency (e.g., 3.2 MHz) for ion attraction are applied to the susceptor as the lower electrode.

A radio frequency power supply unit 13 is provided under the chamber 11. The radio frequency power supply unit 13 includes: a first matcher 14 disposed directly under the chamber 11, for the first radio frequency power; a second matcher 15 disposed under the first matcher 14, for the second radio frequency power; a first radio frequency power supply 16 provided under the second matcher 15, for supplying a first radio frequency power; and a second radio frequency power supply (not shown) provided at a side of the first radio frequency power, for supplying a second radio frequency power.

The radio frequency power supply unit 13 can be raised and lowered by a ball screw mechanism having a ball screw 21. The ball screw mechanism has the linear shafts 22 disposed as elevation guides at both sides of the ball screw 21. The ball screw 21 and the linear shafts 22 provided at both sides thereof are arranged at opposite sides of the etching apparatus 10 with the radio frequency power supply unit 13 interposed therebetween.

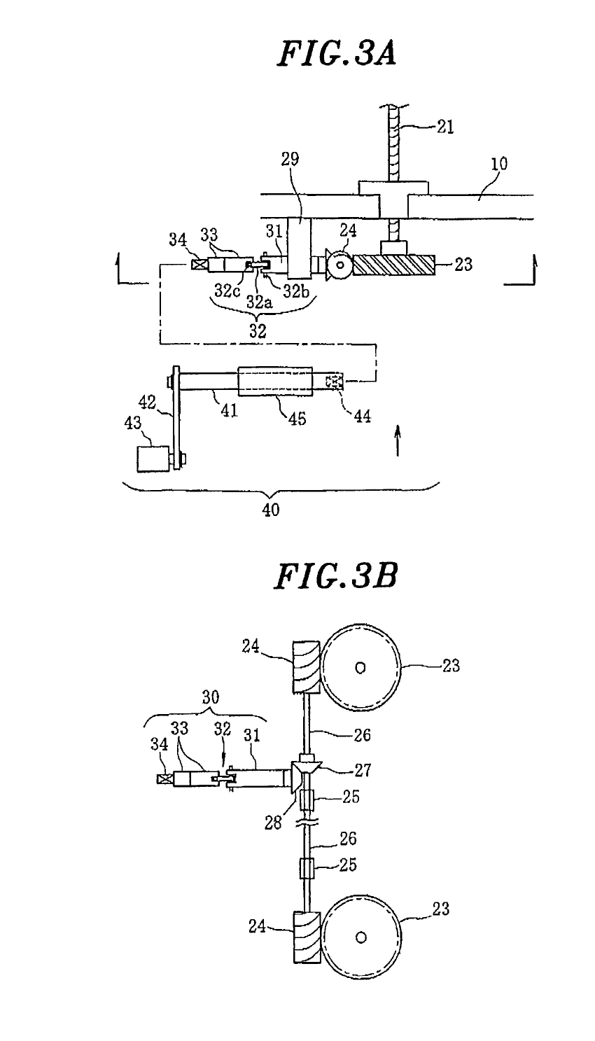

FIGS. 3A and 3B illustrate a configuration of the elevating device, wherein FIG. 3A is a front view thereof seen in the direction of arrow B of FIG. 1, and FIG. 3B is a bottom view thereof. A worm wheel 23 is attached to a bottom portion of each ball screw 21, and worm gears 24 are engaged with the respective worm wheels 23. The shafts of the worm gears 24 are connected to each other by a single cross shaft 26 via respective couplings 25. A bevel gear 27 is fixed between the coupling 25 and the worm gear 24 at one side. Further, the bevel gear 27 is engaged with another bevel gear 28 which is fixed to a base end portion 31 of the rotation axis 30.

The rotation axis 30 has the base end portion 31, a bendable portion 32 and a leading end portion 33. The base end portion 31 is held by a bracket 29 fixed to a frame of the etching apparatus 10. Although the rotation axis 30 is disposed horizontally in the illustrated embodiment, it is not limited thereto. The rotation axis 30 may be disposed at any angle by means of the gear train provided between itself and the ball screw as long as it crosses a vertical direction.

A square pillar-shaped connecting member 34 is provided at an end surface of the leading end portion 33 of the rotation axis 30, and a handle 40 is detachably connected thereto. The handle 40 has a handle shaft 41, a handle bar 42 and a grip 43. A connection recess 44 into which the connecting member 34 is fitted is formed in a leading end of the handle shaft 41. The handle shaft 41 may has a larger diameter portion 45 for easy grip.

The bendable portion 32 transfers rotation, but not bending. The configuration of the bendable portion 32 will now be described in detail. The bendable portion 32 has a link 32a having at both end portions thereof coupling shafts 32b and 32c to be coupled with the rotation axis. The coupling shafts 32b and 32c are extended in different directions. Although they can be positioned at any angle, they are preferably positioned at a right angle. In other words, it is preferable that one coupling shaft 32b is extended vertically and the other coupling shaft 32c is extended horizontally, as shown in the illustrated embodiment.

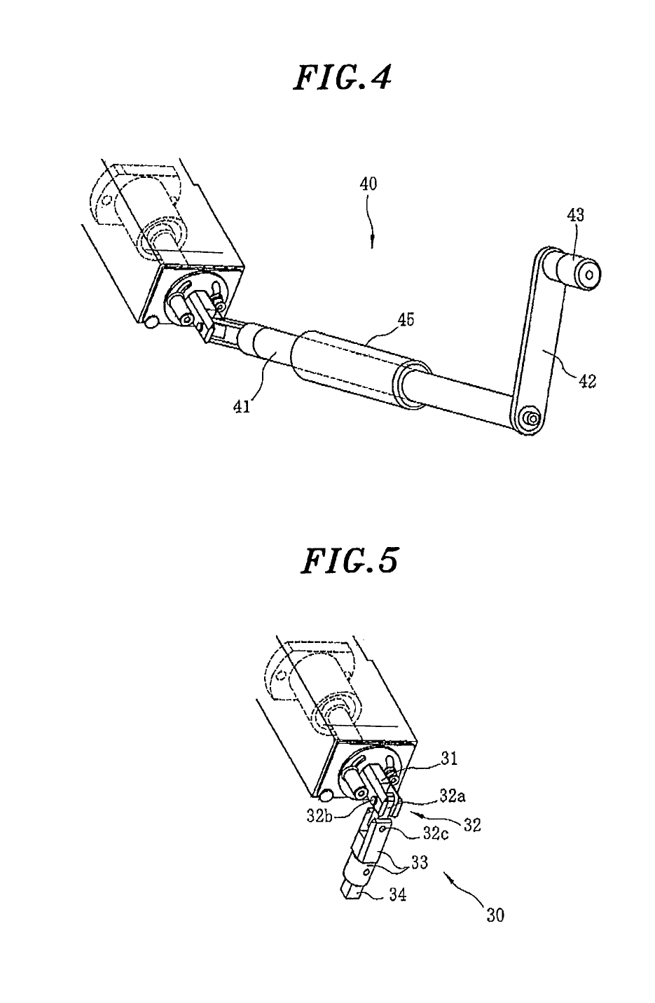

FIG. 4 offers a perspective view depicting a state where the handle 40 is attached to the rotation axis 30. When the connecting member 34 of the leading end portion 33 is fitted into the connection recess 44 of the handle shaft 41 (see, FIG. 3A), the handle 40 is coupled to the rotation axis 30 as shown in FIG. 4. Moreover, when an operator rotates the grip 43 by one hand while holding the larger diameter portion 45 with the other hand, the rotation of the handle 40 is transmitted to the rotation axis 30, and the bevel gear 28 is then rotated. The rotation of the bevel gear 28 is transferred to the bevel gear 27 oriented at a right angle with the bevel gear 28, thereby rotating the cross shaft 26. The cross shaft 26 equally rotates the worm gears 24 provided at both sides thereof. Further, the worm gears 24 rotate the respective worm wheels 23, and the worm wheels 23 rotate the respective ball screws 21 provided at opposite sides. Due to the rotation of the ball screws 21, the radio frequency power supply unit 13 is raised or lowered.

When the radio frequency power supply unit 13 reaches a required height, the elevation operation is completed. Next, the handle shaft 41 is separated from the connecting member 34.

FIG. 5 presents a perspective view showing a state where the handle 40 is separated from the rotation axis 30. When the handle 40 is separated, the leading end portion 33 of the rotation axis 30 is suspended vertically downward from the bendable portion 32. Although the handle 40 is made detachable from the leading end portion 33 in this embodiment, the handle 40 may be integrated with the leading end portion 33 as one unit. In that case, the handle 40 included in the leading end portion 33 is also suspended downward.

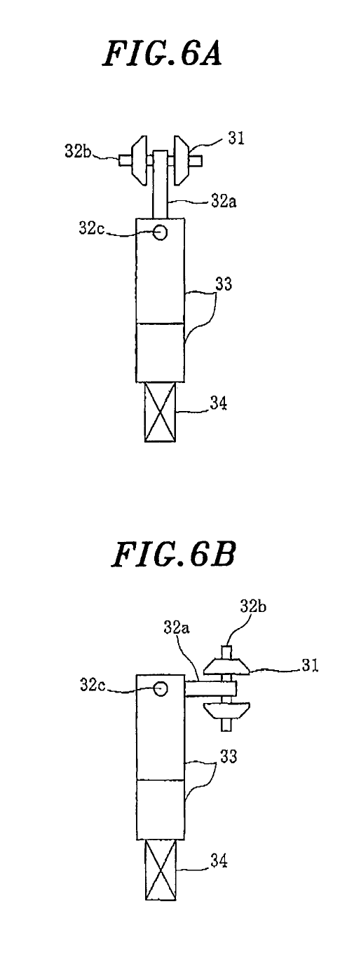

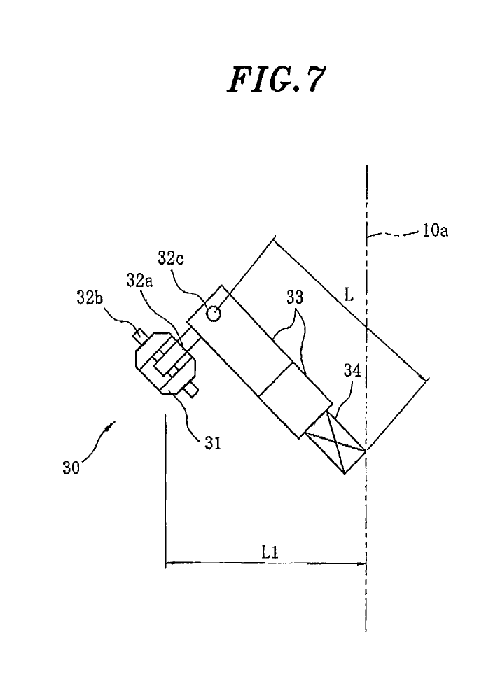

FIGS. 6A and 6B represent a state where the leading end portion 33 of the rotation axis 30 is suspended downward regardless of the position of the rotation axis 30. In FIG. 6A, the base end portion 31 is positioned such that the coupling shaft 32b is horizontally extended and the link 32a rotates about the coupling shaft 32b to be extended vertically with the leading end portion 33 suspended downward therefrom. In FIG. 6B, the coupling shaft 32b is vertically extended. In this case, the leading end portion 33 rotates about the other coupling shaft 32c to be vertically suspended. Even when the base end portion 31 of the rotation axis 30 is positioned at an angle between those shown in FIGS. 6A and 6B, the leading end portion 33 is suspended downward.

When the rotation of the rotation axis 30 stops and the leading end portion 33 is vertically suspended, a rotational torque is applied to the rotation axis 30 by the gravity of the radio frequency power supply unit 13. However, in the present invention, a braking torque applied to the rotation axis 30 by the weight of the leading end portion 33 is set to be larger than the rotational torque due to the gravity of the radio frequency power supply unit 13, so that it is possible to prevent the rotation axis 30 from rotating in the direction that the heavy equipment descends.

FIG. 7 shows another embodiment of the present invention. In this embodiment, the rotation axis 30 is arranged so that a frame 10a of the etching apparatus or the like is spaced apart from the center of the rotation axis 30 by a distance of L1. The rotation of the rotation axis 30 may not stop if the rotational torque due to the gravity of the heavy equipment cannot be suppressed because of a light weight of the leading end portion 33 of the rotation axis 30 or if the heavy equipment receives an acceleration even when the weight of the leading end portion 33 is sufficient to suppress the initial speed. In that case, the rotation axis 30 rotates in, e.g., a counterclockwise direction, from the state of FIG. 6A, and then reaches a position of FIG. 7. At this time, the rotation of the rotation axis 30 can be suppressed by force by setting a distance L between the leading end of the leading end portion 33 and the center of the rotation axis 30 to be larger than the distance L1.

As set forth above, in the elevating device of the present invention, the leading end portion 33 of the rotation axis 30 is connected to the bendable portion 32 and, also, the leading end portion 33 is suspended downward regardless of the stop position of the rotation axis 30. Therefore, it is possible to prevent the heavy equipment or heavy member from descending due to rotation of the rotation axis caused by the gravity of the heavy member. In addition, the unintended descent prevention mechanism of the present invention is reliable because it is almost free from damages or abrasion.

The present invention can be variously modified without being limited to the above embodiments. For example, although the bendable portion 32 in the above embodiments includes the link 32a and the coupling shafts 32b and 32c, it is only an example. The bendable portion 32 may have a different configuration as long as it transmits rotation but not bending. For example, the link 32a may be formed as a spherical body or as strong meshes of steel. Moreover, although one link 32a is provided in the above embodiments of the present invention, two or more links 32a may be connected through coupling shafts.

Although the elevating device using the ball screw is exemplified in the above embodiment, it is also possible for the elevating device to use, e.g., a conventional screw, other than the ball screw.

The present invention can be applied to an elevation of a general heavy member as well as the elevation of the radio frequency power supply unit of the plasma etching apparatus. The aforementioned effects can be achieved in both cases.

While the invention has been shown and described with respect to the preferred embodiments, it will be understood by those skilled in the art that various changes and modifications may be made without departing from the scope of the invention as defined in the following claims.

What is claimed is:

1. An elevating device for raising and lowering a heavy member by rotating a rotation axis extending in a direction crossing a vertical direction, the rotation axis having one end portion to which the heavy member is connected and the other free end portion, wherein the rotation axis comprises a bendable portion adapted to transmit a rotational force and to be bent regardless of a rotation stop position of the rotation axis; and a leading end portion of the free end portion adapted to be vertically suspended from the bendable portion of the rotation axis, a rotation applied by the heavy member to the rotation axis being suppressed by the suspended leading end portion.

2. The elevating device of claim 1, wherein the rotation applied by the heavy member to the rotation axis is suppressed by making a braking torque applied to the rotation axis due to a weight of the suspended leading end portion greater than a rotational torque applied by the heavy member to the rotation axis.

3. The elevating device of claim 1, wherein when the suspended free end portion is rotated by the rotational force applied by the heavy member to the rotation axis, the rotation of the rotation axis is suppressed by the contact between the leading end portion and a wall surface adjacent thereto.

4. The elevating device of claim 1, wherein the bendable portion has one or more links as a part of the rotation axis, and each of the links has both end portions rotatably coupled to another link or the rotation axis through respective coupling shafts extending in different directions.

5. The elevating device of claim 4, wherein the number of the links is one and the coupling shafts provided at both sides of the link are extended perpendicular to each other.

6. The elevating device of claim 1, wherein the rotation axis and the heavy member are connected to each other through a ball screw for raising and lowering the heavy member and a gear train for connecting the ball screw and the rotation axis.
